(19) United States
(12) Patent Application Publication
(10) Pub. No.: US 2021/0150602 A1
(43) Pub. Date: May 20, 2021

(54) METHODS AND SYSTEMS FOR TRANSMITTING INFORMATION TO A MERCHANT

(71) Applicant: CAPITAL ONE SERVICES, LLC, McLean, VA (US)

(72) Inventors: Vijayalakshmi Narasimha Raju KALIDINDI, Frisco, TX (US); Surbhi O'haugherty, Richardson, TX (US); Sebastian Lewis, Dallas, TX (US); Nick Norcross, Frisco, TX (US); Jeffrey Whalen, Frisco, TX (US); Poojitha Ponugoti, Allen, TX (US); Christian Young, Dallas, TX (US)

(73) Assignee: CAPITAL ONE SERVICES, LLC, McLean, VA (US)

(21) Appl. No.: 16/684,151

(22) Filed: Nov. 14, 2019

(51) Int. Cl. G06Q 30/06; G06Q 40/02

(52) U.S. Cl. CPC G06Q 30/0627; G06Q 40/025; G06Q 30/0617

(57) ABSTRACT

A computer-implemented method may include receiving customer information, the customer information including: at least one preference of a customer, the at least one preference including product identification information indicative of the at least one preference of the customer, and a loan prequalification of the customer. The method may also include receiving a request to provide the customer information to a merchant device, transmitting a communication to a merchant management system, the communication including an access code, and providing at least some of the customer information to the merchant device based on the access code received by the merchant device.

### TECHNICAL FIELD

Various embodiments of the present disclosure relate generally to communication with merchants (and/or merchant devices) and, more particularly, to methods and systems for providing customer information to a merchant device.

### BACKGROUND

Merchants involved with the sale of high-price, high-value products rely upon frequent communication with customers to facilitate sales. Effective customer communication is especially necessary in competitive markets in which merchants compete with other merchants that offer similar, or even identical, products. In such environments, customers frequently select a merchant based on the quality of customer service, and the ease with which a product can be evaluated and purchased. A vital component of this customer service is communication between the client and the merchant. Various systems and methodologies exist for establishing and maintaining communication, whether the merchant is reaching out to existing customers or potential new customers. For example, customer management devices, services, or software may facilitate communication between merchants and customers via telephone, marketing mailings, and/or electronic communications (e.g., e-mail).

While customer management devices, services, or software may assist merchants seeking to initiate contact with one or more existing or potential customers, there are limited options available to a customer seeking to initiate or continue a conversation with the merchant. When a customer does seek to initiate contact with one or more merchants, the ability of the customer to provide relevant information to the merchant is limited. Thus, the customer may need to manually (and repeatedly, when more than one merchant is contacted) communicate preferences to the merchant. This is especially problematic when a customer is evaluating the products offered for sale by multiple merchants, the purchase of which involves financing and/or significant expense.

Conventional techniques for financing a vehicle, for example, may include a prospective consumer obtaining pre-qualification financing approval for a vehicle or a loan amount or monthly payment, etc. through a lending site. The pre-qualification approval may be in the form of a letter indicating a pre-qualification status that may then be provided to a dealership as proof of lending capabilities etc. The pre-qualification letter, however, does not provide much information about the prospective consumer that can be used by the dealer to benefit the consumer to help fit the consumer with a vehicle that meets the consumer's financial requirements or vehicle preferences. It would be advantageous to provide a mechanism via which certain financial and/or vehicle preferences of the prospective consumer could be shared with the dealership to enable to an efficient and productive consumer experience at the dealership.

The present disclosure is directed to addressing one or more of these challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for providing customer information to a merchant device. Each of the examples disclosed herein may include one or more of the features described in connection with any of the other disclosed examples.

In one aspect, a computer-implemented method may include receiving customer information, the customer information including: at least one preference of a customer, the at least one preference including product identification information indicative of the at least one preference of the customer, and a loan prequalification of the customer. The method may include receiving a request to provide the customer information to a merchant device, transmitting a communication to a merchant management system, the communication including an access code, and providing at least some of the customer information to the merchant device based on the access code received by the merchant device.

In another aspect, a system for providing customer information to a merchant may include a memory storing instructions and at least one processor executing the instructions to perform a process. The process performed by the at least one processor may include receiving customer information from a customer, the customer information including a vehicle preference of the customer for at least one vehicle, and determining that at least one dealership of a plurality of dealerships possesses a particular vehicle that corresponds to the vehicle preference. The process performed by the at least one processor may also include receiving a request to provide the customer information to a vehicle merchant device associated with the at least one dealership, and providing the customer information to the vehicle merchant device when the at least one dealership possesses the particular vehicle that corresponds to the vehicle preference and based on the request to provide the customer information.

In another aspect, a computer-implemented method may include determining at least one vehicle preference of a customer, the at least one vehicle preference including at least one of a vehicle make, a vehicle model, or a model year indicated by the customer, and receiving a request to provide the at least one vehicle preference to a vehicle merchant device. The method may also include sending a communication to a merchant management system, wherein the communication does not include the at least one vehicle preference of the customer, the communication including an access code to request access to customer information, and providing the customer information to the vehicle merchant device based on the access code received by the merchant management system, the customer information including at least the vehicle preference of the customer, and a budget preference of the customer.

According to additional aspects of the disclosure, a non-transitory computer-readable medium stores instructions that, when executed by one or more processors, cause the one or more processors to perform the aforementioned computer-implemented methods or the operations that the aforementioned system is configured to perform.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic view of an exemplary system environment, according to one or more embodiments.

FIG. 2 is a block diagram illustrating components of the exemplary system environment of FIG. 1, according to one or more embodiments.

FIG. 3A is a representation of an exemplary display presented on a merchant device, according to one or more embodiments.

FIG. 3B is a representation of another exemplary display presented on a merchant device, according to one or more embodiments.

FIG. 4 is a flowchart of an exemplary process for providing customer information to a merchant device, according to one or more embodiments.

FIG. 5 is a flowchart of an exemplary process for providing customer information to a vehicle merchant device, according to one or more embodiments.

FIG. 6 is a block diagram depicting an exemplary system that may execute techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “customer” refers to both individuals who may be engaged, for the first time, with one or more merchants, (e.g., new or prospective customers) as well as individuals who have engaged one or more merchants previously (e.g., past or returning customers).

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as customer information may be provided to one or more merchant devices. The customer information may be provided based on an access code received by the merchant device. The customer information may be provided when at least one merchant possesses a particular vehicle that corresponds to a vehicle preference and/or based on a request to provide the customer information.

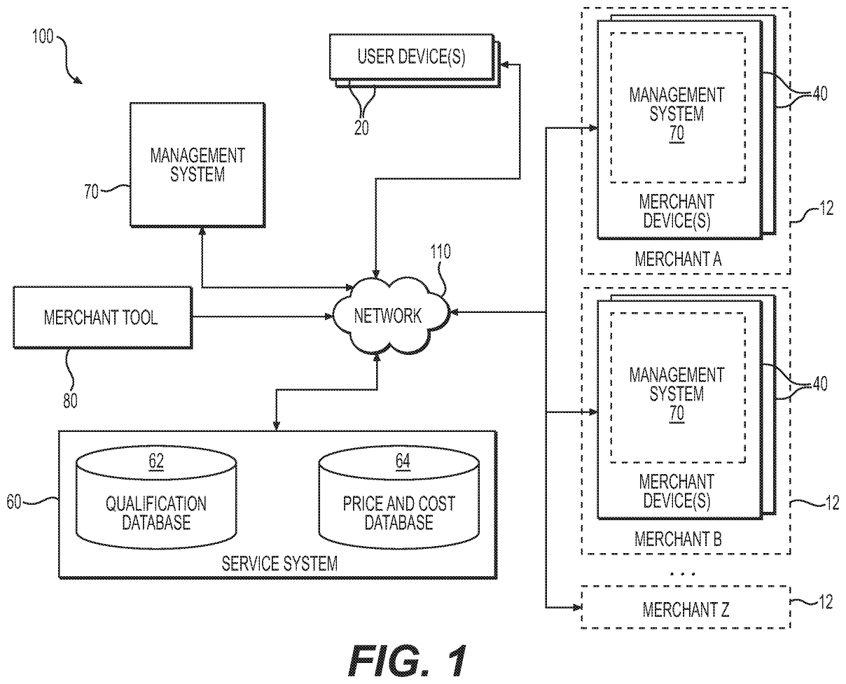

FIG. 1 illustrates an exemplary system environment 100 according to one or more embodiments of the present disclosure. The system environment 100 may include computing devices, such as one or more user devices 20, one or more merchant devices 40, financial service system or service system 60, and merchant tool 80. A plurality of merchants 12 (e.g., vehicle dealerships) may each use one or more of the merchant devices 40. Service system 60 may include financial service databases such as a qualification database 62, a price and cost database 64, and other databases useful in providing customer or product information. A merchant management system 70 may be provided as a separate (stand-alone) entity, may be integrated within one or more merchant devices 40, or may be distributed across multiple devices. Merchant tool 80 may be in communication with each of the user device(s) 20, merchant devices 40, service system 60, and merchant management system 70 via a network 110, which may be the Internet or any other suitable communication infrastructure or network. In one aspect, service system 60 and merchant tool 80 may be integrated with each other (e.g., may be formed by a single device or as part of a distributed platform).

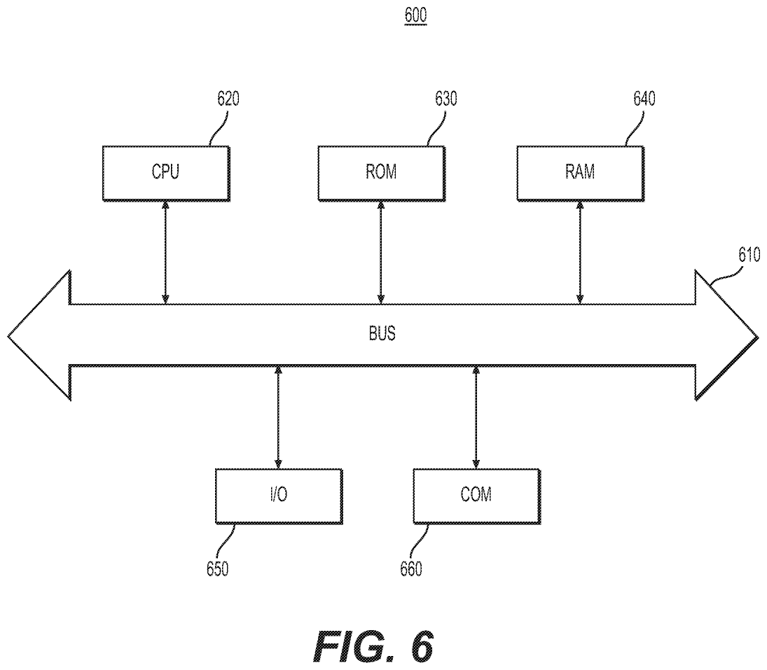

User device(s) 20 may include a computer system such as a desktop computer, mobile computer, or cellular phone that is operated by a user. User device(s) 20 may include memory, one or more processors, communication interfaces, input devices, and output devices, as will be described in further detail below with reference to FIG. 6. A communication interface (e.g., communication interface 660, FIG. 6) may facilitate communication between user device(s) 20 and merchant tool 80 via network 110. A display of user device 20 and/or one or more I/O devices may facilitate entry or modification of customer information via a customer portal, as described below.

Merchants 12 may be provided in a plurality of different physical locations and may possess a stock or inventory of products, such as vehicles. In the example shown in FIG. 1, a first merchant A, a second merchant B, and a Zth merchant Z may each use one or more merchant devices 40 to communicate with network 110. Any number of merchants 12 with any number of merchant devices 40 may be included in system environment 100. In one aspect, merchant devices 40 may include a computer system such as a desktop computer, mobile computer, or cellular phone that is operated by one or more user(s). In one aspect, merchant devices 40 may include a merchant management system or management system 70.

Management system 70 may be provided (e.g., installed as a program or application) on one or more merchant devices 40 that allow the merchant device(s) 40 to operate as a customer-relationship management system. Additionally or alternatively, management system 70 may be provided as a separate device on-site with respect to merchant 12, or as one or more management systems 70 provided off-site (external to) merchant 12. For example, management system 70 may be provided in a distributed network or cloud service. One management system 70 may be in communication with a plurality of merchant devices 40, and may also be in communication with a plurality of merchants 12. In an exemplary configuration, management system 70 of system environment 100 may be in communication with merchant devices 40 of merchants 12 via network 110.

Management system 70 may be a system for facilitating contact between one or more merchants 12 (e.g., operators of merchant device(s) 40) and customers. Management system 70 may, for example, include a database of names, phone numbers, e-mail addresses, prior purchases, etc., in order to facilitate marketing communications, service reminders, recall notices, or other communications from merchant(s) 12 to existing or potential customers.

Service system 60 may include one or more databases that store information for transmission to user device(s) 20, merchant device(s) 40, management system 70, and/or merchant tool 80. Each of these databases 62 and 64 may include one or more storage devices, such as solid-state storage media (e.g., solid state drives and/or removable flash memory), optical storage media (e.g., optical discs), and/or magnetic storage media (e.g., hard disk drives) for storing information. While databases 62 and 64 of service system 60 are illustrated as separate from merchant tool 80, in at least some embodiments, databases 62 and 64 may be incorporated with merchant tool 80. That is, in at least some embodiments, service system 60 and merchant tool 80 may be combined into one single tool/entity.

In one aspect, price and cost database 64 may store price information including, for example, price information for one or more products, such as vehicles. This price information may correspond to a price for a particular (e.g., individual) new or used vehicle, and may be associated with a particular product (e.g., by a unique series of alpha-numeric characters). Price information may be associated with one or more products that are in the possession of or in an inventory of merchant 12. Thus, price information may include inventory information for one or more merchants 12. This inventory information may specify one or more characteristics of a particular product (e.g., make, model, vehicle identification number, mileage, etc.). Inventory information may be received by service system 60 from merchants 12 (via merchant devices 40), from management system 70, and/or from an industry database. Cost information may include tax, title and license information, and may be determined based on a location of a customer, a location of a merchant 12, or both. Cost information, like inventory information, may be received by service system 60 from an industry database. Additionally or alternatively, cost information may be provided by service system 60 itself, based on records of a financial service provider.

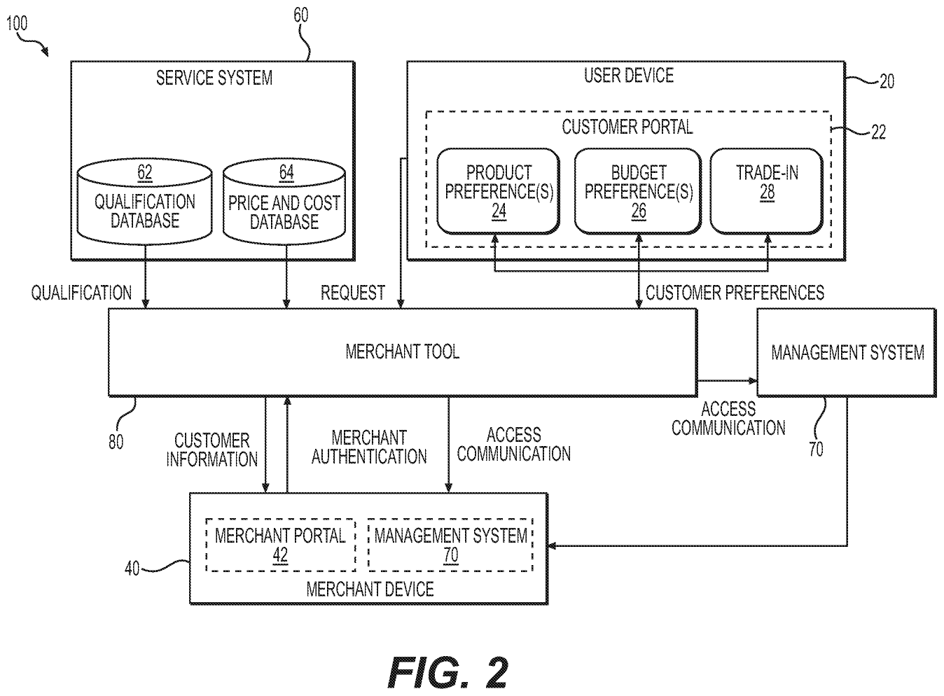

Qualification database 62 may store loan prequalification information or qualification information (included as part of the customer information) corresponding to a user of user device 20. Loan prequalification information may be specific to an individual user and may be determined based on the user's credit worthiness (e.g., a credit score such as a FICO score), a user's income, and/or other factors. Loan prequalification information may include at least one of an approval amount (e.g., a pre-approval dollar value such as a maximum financing amount or an appropriate range of financing), an interest rate (e.g., an Annual Percentage Rate or APR or appropriate range of interest rates indicating a lowest interest rate and a highest interest rate associated with the individual user), a monthly payment, and/or an expiration date for the loan prequalification. One or more items of loan prequalification information (e.g., approval amount, interest rate, APR, monthly payment, and/or expiration date) may be included in a qualification transmission (or qualification) provided by service system 60 to merchant tool 80 (FIG. 2).

Databases 62 and 64 may be in communication with merchant tool 80, and may provide price information, cost information, and/or prequalification information to merchant tool 80. Qualification database 62 of service system 60 may include proprietary and/or confidential information, such as information that may allow for unique identification of an individual (e.g., personally identifiable information (PII) of a customer or user). Such PII may be stored in any appropriate secure fashion (e.g., in an encrypted format). Similarly, the qualification may be transmitted in any appropriate secured fashion. In such a manner, while service system 60 may be in communication with network 110, service system 60 may limit access to one or more categories of information stored therein, or one or more particular pieces of information stored therein.

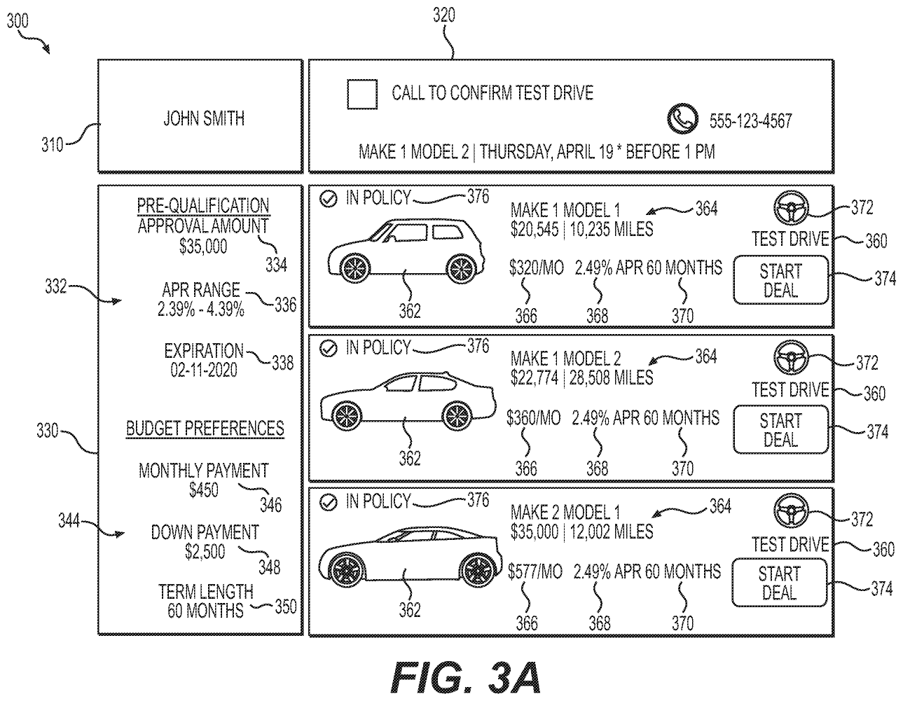

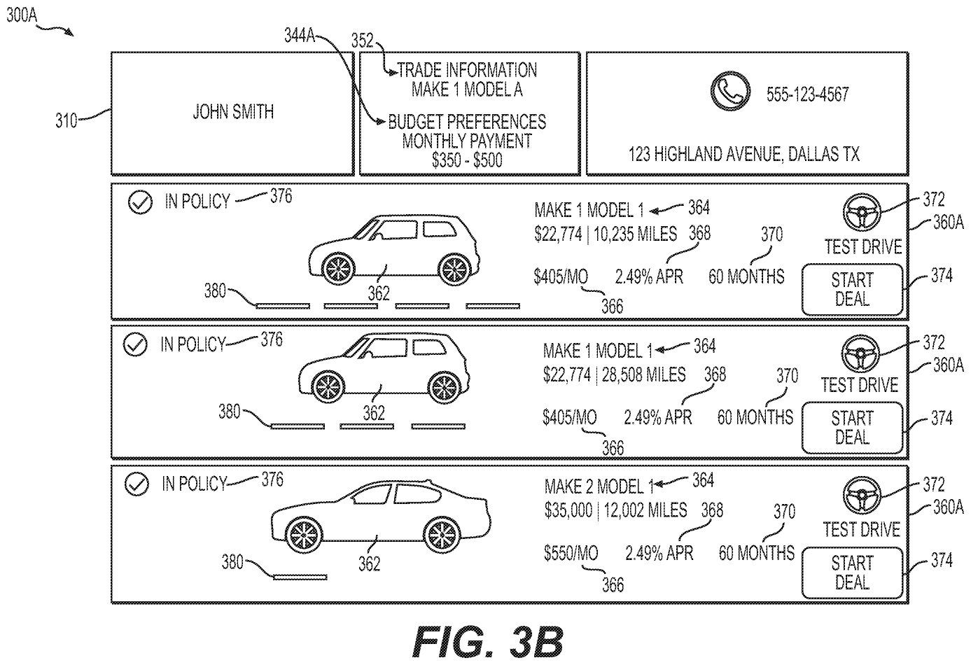

Merchant tool 80 may include a computer system or other computing device or may be provided in a distributed manner across a plurality of devices. Merchant tool 80 may include one or more servers, databases, etc. and may provide a user or customer portal 22 to user device(s) 20 (FIG. 2) and a merchant portal 42 to merchant device(s) 40 (FIGS. 2, 3A, and 3B). It is to be understood that a portal, as described herein, includes applications (e.g., an application installed on user device 20 and/or merchant device 40), Internet websites, Internet-based software applications, or a combination thereof. Regardless of the precise implementation of merchant tool 80, tool 80 facilitates the secure sharing of customer information to merchant device 40.

FIG. 2 is a block diagram illustrating a flow of information and communication between components of system environment 100. As can be seen in FIG. 2, merchant tool 80 is configured to communicate with service system 60, user device(s) 20, merchant device(s) 40, and management system 70. Merchant tool 80 may receive preference information or customer preferences from user device 20, qualification information from qualification database 62, and price information and/or cost information from price and cost database 64. The customer information received from user device 20 and from service system 60 may be stored by merchant tool 80 and updated, added to, or removed, as necessary.

Merchant tool 80 may receive customer information that corresponds to one or more customers. Customer information may include, for example, the prequalification information received in the qualification transmitted from service system 60 via qualification database 62. Customer information may also include at least one customer preference. Customer preferences may include one or more product preferences, one or more budget preferences, and/or one or more potential trade-ins.

Merchant tool 80 may be configured to present user device 20 with customer portal 22. The customer portal 22 may allow a user (e.g., a customer or potential customer) to interact with merchant tool 80 via user device 20. For example, merchant tool 80 may cause a display of user device 20 to display interactive objects, prompts, etc., that allow a customer to input preference information to generate or update customer preferences. In one aspect, one or a plurality of product preferences may be input by a customer interacting with product preferences entry 24. When the product is a vehicle, a product preference entered via entry 24 may be indicative of one or more particular vehicles (e.g., as identified by a unit vehicle identification number), a particular make and/or model, or a particular class of vehicle (e.g., sedan, sports car, truck, etc.). Entry 24 may allow a user to add a series of different product preferences such as vehicles. Additionally, entry 24 may allow a user to specify desired features of a vehicle (e.g., heated seats, a minimum acceptable safety rating, a minimum acceptable gas mileage, etc.), and thus identify a product preference without specifying a particular make or model. The particular vehicle(s) identified via entry 24 may be associated with a particular merchant 12, and may be, for example, a vehicle provided in the inventory of (in the possession of) merchant 12. Customer portal 22 may present entry 24 as a list of products, such as vehicles, that correspond to a particular merchant 12. Entry 24 may be included with an interactive element, such as a button (e.g., a button to “Add new vehicle”) that allows a user of user device 20 to add to a list of product preferences. Thus, product preferences may be set for a plurality of products, as desired by a user.

One or more budget preferences may be input by a customer by interacting with a budget preferences entry 26, and may include one or more of a monthly payment (e.g., a maximum monthly payment or acceptable range of monthly payments), a down payment (e.g., a maximum down payment or acceptable range of down payments), or a loan term length (e.g., a minimum term length, a maximum term length, or a range of acceptable term lengths). Customer information may also include trade-in information specified via trade-in entry 28, which may include information corresponding to a user's trade-in offer (e.g., make, model, trim, mileage, etc.). In one aspect, trade-in information may include or be indicative of an industry value of a trade-in or a proposed value of a trade-in. A user may revise, remove, or update customer preferences by interacting with entries 24, 26, and/or 28. These changes may be provided to merchant tool 80 in real time.

Merchant tool 80 may also receive a request from user device 20, the request being initiated via customer portal 22. For example, the request may be initiated by a user. In one aspect, this request may be indicative of a desire of a customer to share one or more pieces of customer information with a merchant device 40 and thereby provide this customer information to merchant 12. The request may be indicative of a request to share one or more pieces of customer information for a particular product, for example, as identified by a product preference. For example, budget preference(s), trade-in information (when a trade-in is intended to be offered), and loan prequalification may be shared individually, or together with the product preference. The request may be indicative of a request to share one or more particular pieces of customer information (e.g., particular product, budget, or trade-in preference(s)). In one aspect, the request may be indicative of a request to share a subset of this customer information. Thus, a user may be able to select which type(s) of customer information will be shared by interacting with customer portal 22.

In one aspect, merchant tool 80 may receive specific pieces of information for one or more of the product preference, budget preference, and trade-in information input via entry 24, 26, and/or 28, respectively. For example, a product preference for a specific vehicle, and/or a specific value of a maximum monthly payment. Merchant tool 80 may be configured to adjust such information before the information is shared with a merchant via merchant portal 42. This may be performed, for example, by generalizing one or more pieces of customer information. For example, merchant tool 80 may share information indicative of a list of products, such as vehicles, that correspond to a vehicle preference, but that do not identically match the vehicle preference. Additionally or alternatively, a list of products shared via merchant portal 42 may be based on products that are within a budget preference received via entry 26. These adjusted or filtered pieces of information may be displayed via merchant portal 42 (FIG. 3B) to effectively communicate the user's preferences and facilitate communication between the user and the merchant.

In response to the request received by user device 20, merchant tool 80 may generate an access code or access communication. This access communication may be encoded information provided to merchant management system 70. As can be seen in FIG. 2, merchant management system 70 may be located external to merchant device 40 (e.g., a merchant management system 70 provided in a distributed computer system or on a server), and may receive an access communication from merchant tool 80. When the merchant management system 70 is provided external to merchant device 40, the merchant tool 80 may transmit the access communication to merchant management system 70.

Optionally, merchant management system 70 may be included as a component (e.g., software) of merchant device 40. In such a configuration, merchant tool 80 may transmit the access communication directly to merchant device 40. Regardless of the implementation of management system 70, providing the access communication to management system 70 may facilitate a merchant's ability to view or process the access communication when interacting with management system 70 via merchant device 40. However, if desired, the access communication may also be transmitted directly to merchant device 40 without the involvement of management system 70.

The access communication generated and transmitted by merchant tool 80 may facilitate a subsequent transmission of customer information to merchant device 40 via merchant tool 80. In one aspect, the access communication includes encoded information that provides merchant device 40, via a merchant portal 42, the ability to receive customer information from merchant tool 80. In one exemplary configuration, the access code or communication may include an internet URL (uniform resource locator, or other Internet address), unique identifier, or other piece of information necessary to allow merchant device 40 (via merchant portal 42) to gain access to or receive the customer information. In one aspect, the access communication does not contain any information associated with the customer. In one exemplary configuration, the access communication does not include any personally identifiable information of the user (or customer), and thus does not contain the user's name or any other identifying information (e.g., address, social security number, driver's license number, etc.). The access communication may also omit customer information.

In one aspect, the access communication includes, or provides access to, computer-readable (machine-readable) content. For example, when the access communication is a URL, this URL may be received by merchant management system 70 and presented to a merchant using merchant device 40. When the merchant (e.g., merchant 12) follows the URL, merchant tool 80 may transmit the customer information to merchant device 40 and cause a display of merchant device 40 to display merchant portal 42. Merchant portal 42 may display one or more piece(s) of customer information and/or one or more adjusted piece(s) of this information, as described below with reference to FIGS. 3A and 3B. When the content of the access communication is machine readable, management system 70 may take action in response to the receipt of the access communication. For example, management system 70 may provide a prompt or send a separate communication to merchant device 40. Thus, a user of merchant device 40 (e.g., a merchant 12) may be notified that a user of user device 20 has generated a request to share customer information.

Merchant tool 80 may request an authentication from the merchant device 40 after transmitting the access communication but before transmitting the customer information. The authentication may be in the form of a username, password, and/or second-factor authentication (e.g., via e-mail or SMS message). Thus, access to customer information may be limited to appropriate personnel of merchant 12.

FIG. 3A provides a depiction of an exemplary display 300 presented by a display device of merchant device 40. Display 300 may be implemented by merchant portal 42 and provided to merchant device 40 by merchant tool 80. Thus, display 300 may present customer information received from merchant tool 80. As can be seen in FIG. 3A, display 300 may include a customer indicator 310, merchant prompt 320, and a customer preference indicator 330. The information displayed in display 300 may correspond to customer information transmitted by merchant tool 80 to merchant device 40. When a user of user device 20 updates information via customer portal 22, this information may be provided to merchant tool 80 immediately, allowing merchant tool 80 to update corresponding portions of display 300 in real time. In one aspect, the access communication may provide access to a hosted service (e.g., when the access communication is formed as a URL linking to a webpage) that causes the presentation of display 300, or display 300A described below. This hosted service may be associated with or included in merchant tool 80, or with another backend system, and may be part of a common backend system for causing the presentation of a display similar to display 300 on user device 20. Thus, when one or more customer preferences are entered, updated, or changed, these changes may be stored within the same backend system as the system that generates display 300. This information may be employed to generate one or more elements of display 300A, as described below.

Customer indicator 310 may illustrate information necessary to identify a customer (the user of user device 20 from which the customer information originated). This customer indicator 310 may include information, such as a name, which was received in the customer information and which was not included in the access communication.

Merchant prompt 320 may display one or more prompts that assist the merchant with upcoming tasks. Additionally, merchant prompt 320 may include interactive features that allow the merchant to initiate communication with the user of user device 20. In one aspect, merchant prompt 320 may allow the merchant to initiate a telephone call or view upcoming appointments.

Customer preference indicator 330 may present one or more pieces of customer information that corresponds to the customer information received from service system 60 and user device 20. In one aspect, information contained in the qualification from qualification database 62 may be used to present a prequalification image 332. Prequalification image 332 may include at least one of an approval amount image 334 (e.g., indicative of a maximum financing amount or appropriate range of financing), an interest rate image 336 (e.g., indicative of an APR or an appropriate range of interest rates indicating a lowest interest rate and a highest interest rate associated with the individual user), and/or an expiration image 338 (e.g., indicative of a final date on which the prequalification may be valid). Budget preferences received from user device 20 via merchant tool 80 may be displayed in a budget preferences image 344 of customer preference indicator 330. Budget preferences image 344 may include at least one of a monthly payment image 346 (e.g., indicative of a maximum monthly payment or acceptable range of monthly payments), a down payment image 348 (e.g., indicative of a maximum down payment or acceptable range of down payments), or a term length image 350 (e.g., indicative of a minimum term length, a maximum term length, or a range of acceptable term lengths). When an image is provided in the form of a range, the displayed range may be generated by adjusting or generalizing a particular value input by a user.

In an exemplary configuration, a central portion of customer preference indicator 330 of display 300 may present one or more product preference images 360. Each product preference image 360 may be based on products within an inventory of merchant 12 that correspond to products identified via product preferences entry 24, including products that are similar to one or more products identified via entry 24. Product preference image 360 may include a product image 362 and product identifier 364 that present identifying information for the product. As can be seen in FIG. 3A, in an example where the product is a vehicle, an image of the vehicle may be presented in product image 362 while product identifier 364 may specify the make, model, price, vehicle identification number, and/or mileage of the vehicle. Product preference image 360 may include a product payments image 366, product interest rate image 368, or a loan term length image 370 that correspond to the product in product preference image 360. The information depicted in the product payments image 366, product interest rate image 368, and/or loan term length image 370 may correspond to information contained in the budget preferences and/or information received in the qualification. Product preference image 360 may include a policy indicator 376 that provides an indication whether a particular product and/or associated budget information falls within one or more lending criteria associated with the qualification. Product preference image 360 may also include a product evaluation prompt 372 to schedule or otherwise initiate a product evaluation with the user identified in indicator 310. A product negotiation prompt 374 may allow a merchant to initiate a negotiation process with the user identified in customer indicator 310.

In one aspect, merchant tool 80 may be configured to facilitate, on user device 20, a display similar to display 300. In such a display, prompt 374 may allow a user to share information with merchant 12 (e.g., when present at a location of dealer 12), including a product preference (e.g., a particular product in the inventory of dealer 12 and/or at the location of dealer 12). Thus, prompt 374 may correspond to the above-described request from user device 20. In response to this request, merchant tool 80 may present merchant portal 42, including display 300 (or display 300A, described below), to assist the user with browsing products and completing a purchase based on the qualification. In one aspect, merchant tool 80 may suggest one or more alternative products based on a product and/or budget preference. This suggestion may also be based on the qualification. Thus, the user may be able to share such information, including qualification information, without the need to complete additional steps such as filling in physical or electronic forms, when the qualification is provided via merchant tool 80.

FIG. 3B provides a depiction of a display 300A illustrating an exemplary display of merchant device 40 that may be implemented by merchant portal 42. Merchant tool 80 may share, via display 300A, one or more pieces of adjusted or generalized customer information. For example, while customer preferences received from customer portal 22 may be specific values or identify a specific product, the actual information shared via display 300A may be in the form of ranges or similar products.

In one aspect, display 300A may present one or more product preference images 360A that correspond to a product in the inventory of a merchant 12, and one or more items of associated information as described above with respect to FIG. 3A. The products presented in display 300A may be presented based on one or more product preferences received by user device 22. A preference image 380 may be indicative of a degree to which the product present in the inventory of merchant 12 matches (corresponds to) the product preference(s) of the user. This preference image 380 may provide a graphical (or alternatively, numerical) range to merchant 12 indicative of the preference(s) of the user. For example, preference image 380 may be provided as a series of bars (FIG. 3B), a series of icons (e.g., stars, circles, etc.), or a numerical value (e.g., a value between 1 and 5, a percentage).

Display 300A may also include a trade-in image 352 representative of a trade-in preference entered via entry 28. The trade-in information may be adjusted to share a make, a model, a mileage, an approximate value, etc., of a potential trade-in product. Thus, merchant tool 80 may generalize information shared with merchant 12. Alternatively, more specific trade-in information (e.g., a particular trade-in value), may be shared via trade-in image 352, for example in response to a request initiated via user device 22 to share more specific or granular information. A budget preferences image 344 may similarly be shared to merchant 12 after being adjusted or generalized. In the exemplary display 300A in FIG. 3B, a particular monthly payment value (e.g., as received via entry 26), may be generalized as a range and presented to merchant 12.

Other pieces of customer information may be adjusted or generalized in the manner described above before being transmitted to merchant device 40. By sharing adjusted or generalized customer information in this manner, the user may effectively communicate preferences without the need to share specific values or particular preferences.

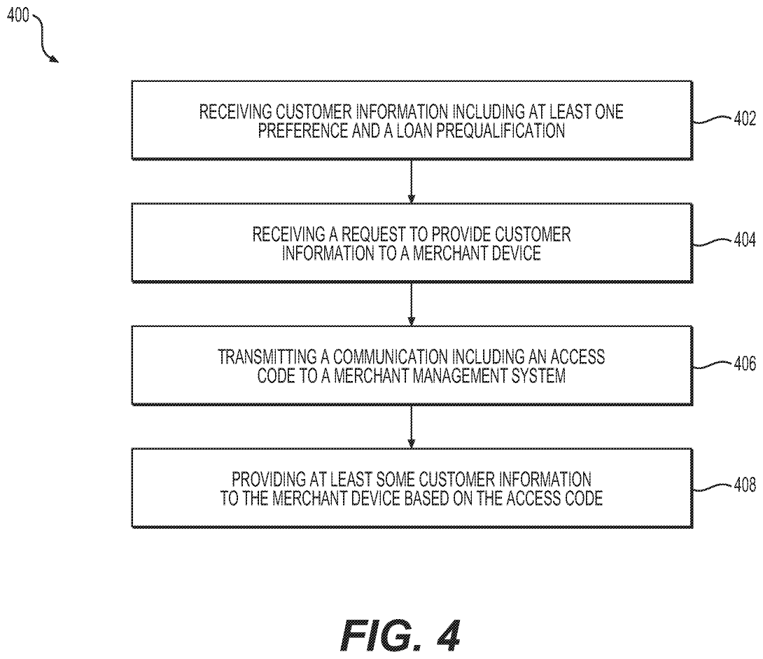

FIG. 4 is a flowchart illustrating a computer-implemented method 400 for providing at least some customer information to merchant device 40. In a step 402 of method 400, customer information may be received, for example by merchant tool 80. This customer information may include at least one preference of a customer (e.g., user of user device 20). This preference may include a product preference (e.g., as entered via entry 24), one or more budget preferences (e.g., as entered via entry 26), and/or one or more trade-ins (e.g., as entered via entry 28). The received customer information may also include loan prequalification information of the customer that is received by merchant tool 80 from service system 60.

In step 404, merchant tool 80 may receive a request to provide one or more of the pieces of the customer information received in step 402 to a merchant device 40. The request received in step 404 may be initiated by user device 20 via customer portal 22. If desired, this request may omit (not include) customer information (the product preference, budget preference, trade-in, or qualification). If desired, the request may be associated with a particular user associated with user device 20 and/or customer portal 22 (e.g., a customer logged in to customer portal 22). The user associated with user device 20 may be identified in an anonymous manner.

In response to the receipt of the request in step 404, merchant tool 80 may transmit or otherwise provide a communication to merchant management system 70 in step 406. The communication transmitted in step 406 may, in one aspect, omit any personally-identifiable information of the customer. Thus, the access communication between merchant management system 70 and merchant tool 80 may avoid the transmission of prequalification information, product preferences, budget preferences, trade-in, etc., and may provide increased data security. As described above, the access communication may include an internet URL (uniform resource locator), access code, unique identifier, or other piece of information necessary to allow merchant device 40 (via merchant portal 42) to gain access to or receive the customer information, without including the actual customer information in the access communication itself. The access communication may provide a merchant (e.g., user) of merchant device 40 to gain access to the customer information corresponding to the request received by merchant tool 80 in step 404.

In a step 408, the merchant may interact with merchant portal 42 via merchant device 40 to receive and view the customer information corresponding to the request of step 404. In one aspect, in step 408, merchant tool 80 may provide at least some of the customer information to merchant device 40 via merchant portal 42. For example, merchant portal 42 may present some (and in some examples all) of the customer information (e.g., via display 300, FIGS. 3A, 3B) to the merchant based on the receipt of the access communication by the merchant device 40. When user device 20 requests that only particular pieces of customer information are shared in step 404, only this information is provided the merchant device 40.

Additionally, in step 408, merchant tool 80 may require an authorization or authentication before providing the customer information to merchant device 40 via merchant portal 42. For example, merchant device 40 may present the user with a prompt for a password or otherwise validate the identity of the user of merchant device 40. Based on this authorization of validation, one or more pieces of customer information may be omitted from the provision of customer information in step 408.

The information provided in step 408 may be updated in real time once the request is received in step 404. Thus, when a user's information is updated, e.g., via entries 24, 26, and/or 28, the display 300 provided by merchant portal 42 may be updated in real time in response to the updated information. Additionally, when an updated or changed qualification is provided by service system 60, the corresponding customer information may be updated in real time in display 300.

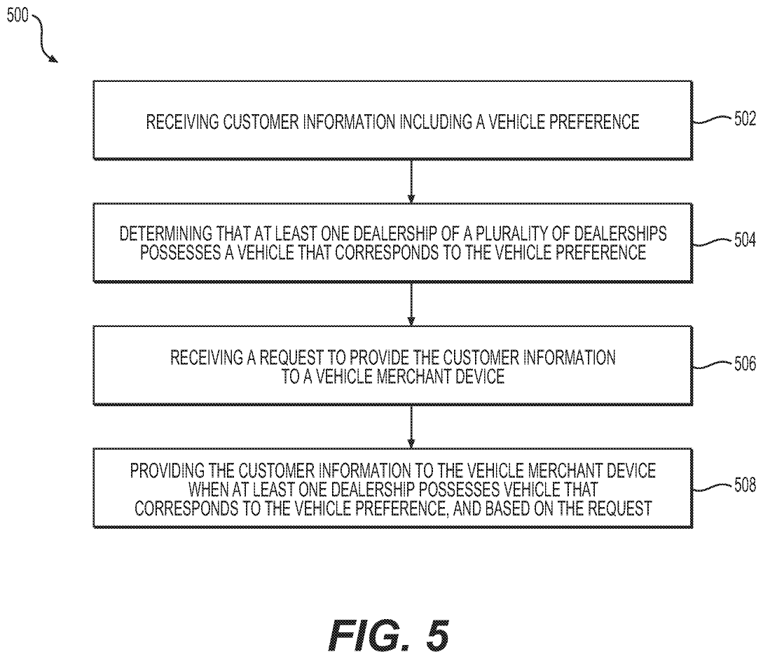

FIG. 5 is a flowchart illustrating a computer-implemented method 500 for providing customer information to a merchant device 40. In a step 502 of method 500, customer information, including a product (e.g., vehicle) preference may be received by merchant tool 80. Step 502 may be performed in a manner similar to step 402. Step 502 may include receiving only the product or vehicle preference for the customer, or may include receiving additional pieces of customer information in addition to a vehicle preference.

In a step 504, merchant tool 80, after receiving the vehicle preference, may determine whether at least one merchant 12 possesses a vehicle corresponding to the vehicle preference received in step 502. A vehicle that “corresponds to the vehicle preference” is understood to include a vehicle that is identical to the vehicle preference (as determined based on a vehicle identification number, for example) or a vehicle that matches to a threshold degree items included in the vehicle preference such as a make, a model, a trim, and/or class in common with the product preference. For example, a vehicle may “correspond to the vehicle preference” when at least a predetermined number of items included in the vehicle preferences match corresponding items of the vehicle preference. This determination may be made based on an identification of a particular dealer included in the information received in step 502. Step 504 may include comparing the vehicle preference of the customer to an inventory of vehicles of one or more vehicle merchants 12. In one aspect, information from price and cost database 64 may provide merchant tool 80 with inventory information for one or more merchants 12. This inventory information may be compared to the vehicle preference received in step 502 to determine if a corresponding vehicle is in the possession (inventory) of one or more vehicle merchants 12.

In step 506, merchant tool 80 may receive a request from user device 20 via customer portal 22 to provide customer information to merchant device 40. This may be performed in a manner similar to step 404 described above. In step 506, customer portal 22 may present the customer with the option to share customer information with a merchant 12 that possesses a vehicle that corresponds to the vehicle preference received in step 502.

In step 508, the customer information may be provided to the merchant device 40 via merchant portal 42. In one aspect, the provision of this customer information may be based on a determination that the merchant (e.g., dealership) 12 corresponding to merchant device 40 possesses a particular vehicle that corresponds to the vehicle preference (e.g., is identical to the vehicle preference) or matches to a threshold degree items included in the vehicle preference such as a make, model, trim, and/or class. The determination that merchant 12 possess a vehicle corresponding to the vehicle preference may be based on a match between a predetermined number of items included in the vehicle preferences and items of the vehicle preference. Additionally, step 508 may include providing customer information based on the request to provide the customer information. Thus, customer information is not provided from merchant tool 80 to merchant device 40 unless user device 20 (via customer portal 22, for example), transmits a request to merchant tool 80 requesting that one or more pieces of customer information be shared with the merchant device 40. Step 508 may also include authenticating the user of the merchant device 40 prior to providing any customer information via merchant portal 42.

The disclosed methods and systems may facilitate the provision of customer information from the customer to one or more merchants 12. The merchant 12 may be provided with the ability to review customer prequalification information, interested vehicles, and other preferences. Thus, barriers to communication between the merchant 12 and the customer are reduced and a conversation is facilitated. By allowing the merchant the ability to view changes in the preferences immediately following a change in one or more of these preferences, the customer is able to provide the merchant 12 with accurate customer information, thereby lending itself to efficient and productive interactions between parties.

FIG. 6 is a simplified functional block diagram of a computer that may be configured to execute techniques described herein, according to exemplary embodiments of the present disclosure. Specifically, the computer (or “platform” as it may not a be a single physical computer infrastructure) may include a data communication interface 660 for packet data communication. The platform also may include a central processing unit (“CPU”) 620, in the form of one or more processors, for executing program instructions. The platform may include an internal communication bus 610, and the platform also may include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method, comprising:
receiving first data from a customer device associated with a customer, the first data including information associated with at least one product preference of the customer;
receiving a request from the customer device to provide at least a portion of the first data to a merchant;
in response to receiving the request, facilitating a secure sharing of information associated with the customer to the merchant, by:
retrieving second data, the second data including information associated with a loan prequalification of the customer;
generating an access communication associated with the request; and
transmitting the access communication to a merchant device associated with the merchant;
providing a merchant portal that is accessible over a network;
receiving a transmission from the merchant device that is based on the access communication; and
in response to receiving the transmission, providing the at least a portion of the first data and at least a portion of the second data to the merchant device via the merchant portal.

2. The method of claim 1, wherein the first data includes a budget preference of the customer, the budget preference including at least one of a monthly payment, a down payment, or a loan term length.

3. The method of claim 1, wherein the loan prequalification of the customer includes an interest rate or an approval amount.

4. The method of claim 1, wherein the first data includes trade-in information including at least a value of a proposed trade-in product of the customer.

5. The method of claim 1, wherein the loan prequalification of the customer is received from a financial services database.

6. The method of claim 1, wherein the first data corresponds to one of a plurality of vehicle models.

7. The method of claim 1, further including requesting an authentication from the merchant device prior to providing the first data to the merchant device.

8. The method of claim 1, wherein the access communication does not include personally identifiable information of the customer.

9. The method of claim 1, wherein the transmitting the access communication includes transmitting a machine-readable communication to a customer-relationship management device.

10. The method of claim 1, wherein the information associated with at least one product preference of the customer includes one or more of a vehicle make, a vehicle model, or a vehicle production year indicative of a vehicle in a dealership stock.

11. A system for providing customer information to a dealership, the system comprising:
a memory storing instructions; and
at least one processor executing the instructions to perform a process including:
receiving customer information from a customer device associated with a customer, the customer information including a vehicle preference of the customer for at least one vehicle;
determining that at least one dealership of a plurality of dealerships possesses a particular vehicle that corresponds to the vehicle preference;
in response to the determining, causing the customer device to display an indication of the at least one dealership;
receiving a request, from the customer device, to provide the customer information to the at least one dealership; and
in response to receiving the request, securely providing the customer information to at least one vehicle merchant device associated with the at least one dealership.

12. The system of claim 11, wherein the customer information includes a plurality of vehicle preferences indicative of a plurality of vehicle models.

13. (canceled)

14. The system of claim 11, wherein the vehicle preference is indicative of a single vehicle of a dealership stock.

15. The system of claim 11, wherein the vehicle preference is indicative of a plurality of vehicles of a plurality of dealership stocks.

16. The system of claim 11, wherein the customer information includes at least one budget preference of the customer.

17. The system of claim 16, wherein the at least one budget preference includes one or more of a monthly payment, a down payment, or a loan term.

18. The system of claim 11, wherein the process executed by the at least one processor further includes providing a communication to the at least one vehicle merchant device based on the request to provide the customer information to the vehicle merchant device.

19. The system of claim 18, wherein the communication to the vehicle merchant device does not include the customer information.

20. A computer-implemented method comprising:
determining at least one vehicle preference of a customer, the at least one vehicle preference including at least one of a vehicle make, a vehicle model, or a model year indicated by the customer;
receiving a request, from a customer device associated with the customer, to provide the at least one vehicle preference to a vehicle merchant;
sending a communication to a merchant management system accessible to a vehicle merchant device associated with the vehicle merchant, wherein the communication does not include the at least one vehicle preference of the customer, the communication including an access code configured to enable access to information associated with the customer;
providing a merchant portal accessible over a network;
receiving a transmission from the vehicle merchant device that includes the access code; and
in response to receiving the transmission, securely providing the information associated with the customer to the vehicle merchant device via the merchant portal, the information associated with the customer including at least the vehicle preference of the customer, and a budget preference of the customer.
